(19) United States
(12) Patent Application Publication
(10) Pub. No.: US 2026/0287229 A1
(43) Pub. Date: Sep. 24, 2026

(54) ADVANCED THERMAL MANAGEMENT SYSTEMS WITH THERMOELECTRIC COLD PLATE COOLANT SYSTEM

(71) Applicant: FAIZAN AHMED, SAN JOSE, CA (US)

(72) Inventor: FAIZAN AHMED, SAN JOSE, CA (US)

(21) Appl. No.: 19/537,950

(22) Filed: Feb. 12, 2026

Related U.S. Application Data
(60) Provisional application No. 63/770,890, filed on Mar. 12, 2025.
(60) Provisional application No. 63/770,883, filed on Mar. 12, 2025.
(60) Provisional application No. 63/770,874, filed on Mar. 12, 2025.
(60) Provisional application No. 63/770,870, filed on Mar. 12, 2025.
(60) Provisional application No. 63/770,866, filed on Mar. 12, 2025.
(60) Provisional application No. 63/770,791, filed on Mar. 12, 2025.
(60) Provisional application No. 63/770,782, filed on Mar. 12, 2025.
(60) Provisional application No. 63/770,585, filed on Mar. 12, 2025.
(60) Provisional application No. 63/770,591, filed on Mar. 12, 2025.
(60) Provisional application No. 63/770,592, filed on Mar. 12, 2025.
(60) Provisional application No. 63/770,785, filed on Mar. 12, 2025.
(60) Provisional application No. 63/772,735, filed on Mar. 16, 2025.
(60) Provisional application No. 63/772,742, filed on Mar. 17, 2025.
(60) Provisional application No. 63/772,743, filed on Mar. 17, 2025.
(60) Provisional application No. 63/772,741, filed on Mar. 17, 2025.
(60) Provisional application No. 63/772,740, filed on Mar. 17, 2025.
(60) Provisional application No. 63/772,739, filed on Mar. 17, 2025.
(60) Provisional application No. 63/772,738, filed on Mar. 17, 2025.

(51) Int. Cl. F25B 49/00; F25B 21/02; F28D 1/02; G01K 3/00

(52) U.S. Cl. CPC F25B 49/00; F25B 21/02; F28D 1/024; G01K 3/005

(57) ABSTRACT

A thermoelectric cold plate coolant system comprising a cold plate body having a substantially planar top surface and a thickness of approximately 1 mm to 3 mm, said cold plate body containing internal coolant circulation channels. A plurality of thermoelectric cooling chips are permanently bonded to said top surface, each chip comprising semiconductor pellet pairs between electrically conductive traces inducing thermoelectric cooling when current is applied. A coolant inlet port and outlet port communicate with said internal channels. A radiator assembly comprising a finned heat exchanger and forced-air cooling device dissipates thermal energy through forced convection. A coolant circulation pump maintains single-phase liquid circulation through a closed loop comprising said cold plate body and radiator assembly. An electrical power supply provides power to said chips, pump, and cooling device.

### CLAIM OF PRIORITY

This application claims priority to U.S. Provisional Patent Application No. 63/772,742, filed on Mar. 17, 2025. This provisional patent application is hereby incorporated by reference in its entirety.

This application claims priority to U.S. Provisional Patent Application No. 63/772,743 and filed on Mar. 17, 2025. This provisional patent application is hereby incorporated by reference in its entirety.

This application claims priority to U.S. Provisional Patent Application No. 63/772,741, filed on Mar. 17, 2025. This provisional patent application is hereby incorporated by reference.

This application claims priority to U.S. Provisional Patent Application No. 63/772,740, filed on Mar. 17, 2025. This provisional patent application is hereby incorporated by reference.

This application claims priority to U.S. Provisional Patent Application No. 63/772,739, filed on Mar. 17, 2025. This provisional patent application is hereby incorporated by reference.

This application claims priority to U.S. Provisional Patent Application No. 63/772,738, filed on Mar. 17, 2025. This provisional patent application is hereby incorporated by reference.

This application claims priority to U.S. Provisional Patent Application No. 63/772,735, filed on Mar. 16, 2025. This provisional patent application is hereby incorporated by reference.

This application claims priority to U.S. Provisional Patent Application No. 63/770,890, filed on Mar. 12, 2025. This provisional patent application is hereby incorporated by reference.

This application claims priority to U.S. Provisional Patent Application No. 63/770,883, filed on Mar. 12, 2025. This provisional patent application is hereby incorporated by reference.

This application claims priority to U.S. Provisional Patent Application No. 63/770,874, filed on Mar. 12, 2025. This provisional patent application is hereby incorporated by reference.

This application claims priority to U.S. Provisional Patent Application No. 63/770,870, filed on Mar. 12, 2025. This provisional patent application is hereby incorporated by reference.

This application claims priority to U.S. Provisional Patent Application No. 63/770,866, filed on Mar. 12, 2025. This provisional patent application is hereby incorporated by reference.

This application claims priority to U.S. Provisional Patent Application No. 63/770,791, filed on Mar. 12, 2025. This provisional patent application is hereby incorporated by reference.

This patent application claims priority to U.S. Provisional Patent Application No. 63/770,782, filed on Mar. 12, 2025. This U.S. Provisional Patent Application is hereby incorporated by reference in its entirety.

This application claims priority to U.S. Provisional Patent Application No. 63/770,585, filed on Mar. 12, 2025. This U.S. Provisional Patent Application is hereby incorporated by reference in its entirety.

This patent application claims priority to U.S. Provisional Patent Application No. 63/770,591, filed on Mar. 12, 2025. This U.S. Provisional Patent Application is hereby incorporated by reference in its entirety.

This patent application claims priority to U.S. Provisional Patent Application No. 63/770,592, filed on Mar. 12, 2025. This U.S. Provisional Patent Application is hereby incorporated by reference in its entirety.

This application claims priority to U.S. Provisional Patent Application No. 63/770,785 filed on Mar. 12, 2025. U.S. Provisional Patent Application No. 63/770,785 is incorporated by reference in its entirety.

### BACKGROUND

### Field of the Invention

The present invention relates generally to portable temperature-controlled storage systems, and more particularly to an advanced thermal management systems with thermo-electric cold plate coolant system.

### Background

Temperature-sensitive materials, particularly in medical and biological applications, require precise temperature control during storage and transport. Traditional cooling systems rely on compressors, refrigerants, or ice packs that are bulky, inefficient, and unable to maintain consistent temperatures. Current portable cooling solutions face significant challenges in maintaining precise temperatures while operating on battery power.

The limitations of existing portable cooling systems are particularly evident in applications requiring extended autonomous temperature control. Traditional compressor-based systems consume significant power and are impractical for portable use, while passive cooling solutions using ice packs or phase change materials cannot maintain precise temperature control over long periods.

Additionally, existing systems often suffer from inefficient heat transfer between cooling elements and payload chambers, leading to temperature gradients and inconsistent cooling. This technical challenge is particularly acute in compact portable systems where space constraints limit traditional heat transfer approaches.

### BRIEF SUMMARY OF THE INVENTION

A thermoelectric cold plate coolant system comprising a cold plate body having a substantially planar top surface and a thickness of approximately 1 mm to 3 mm, said cold plate body constructed from a thermally conductive material and containing an internal network of coolant circulation channels. The system further comprises a plurality of thermoelectric cooling chips affixed to said top surface of said cold plate body, each said thermoelectric cooling chip comprising a plurality of semiconductor pellet pairs arranged between electrically conductive traces, wherein electrical current applied to said conductive traces induces thermoelectric cooling at a top surface of each said chip and heat generation at a bottom surface of each said chip. Said thermoelectric cooling chips are permanently bonded to said cold plate body through soldering or thermally conductive adhesive bonding to eliminate thermal interface resistance. The system further comprises a coolant inlet port and a coolant outlet port in fluid communication with said internal network of coolant circulation channels. The system further comprises a radiator assembly in fluid communication with said coolant outlet port, said radiator assembly comprising a finned heat exchanger and a forced-air cooling device, wherein said radiator assembly is configured to dissipate thermal energy from heated liquid coolant to ambient air through forced convection. The system further comprises a coolant circulation pump configured to maintain continuous single-phase liquid circulation through a closed loop comprising said cold plate body and said radiator assembly, wherein said liquid coolant remains in liquid phase throughout said closed loop during normal operation. The system further comprises an electrical power supply configured to provide electrical power to said thermoelectric cooling chips, said coolant circulation pump, and said forced-air cooling device.

### BRIEF DESCRIPTION OF THE DRAWINGS

FIG. 1 is a top view of example embodiment of a portable temperature-controlled enclosure, according to some embodiments.

FIGS. 2 and 3 are isometric views of example embodiment of a portable temperature-controlled enclosure, according to some embodiments.

FIG. 4 is a front view of example embodiment of a portable temperature-controlled enclosure, according to some embodiments.

FIG. 5 is a side view of example embodiment of a portable temperature-controlled enclosure, according to some embodiments.

FIG. 6-9 illustrate various example views of an aluminum cooling chamber portable unit, according to some embodiments.

FIG. 6 illustrates a top-view of aluminum cooling chamber portable unit, according to some embodiments.

FIG. 7 illustrates a isometric-view of aluminum cooling chamber portable unit, according to some embodiments.

FIG. 8 illustrates a rear-view of aluminum cooling chamber portable unit, according to some embodiments.

FIG. 9 illustrates a side-view of aluminum cooling chamber portable unit, according to some embodiments.

FIG. 10 is a block diagram of a sample computing environment that can be utilized to implement various embodiments.

FIG. 11 illustrates a logical view of a portable temperature-controlled enclosure, according to some embodiments.

FIG. 12 illustrates an exploded view of the thermoelectric cold plate coolant system assembly, according to some embodiments.

FIG. 13 illustrates an alternative perspective view of the thermoelectric cold plate coolant system assembly, according to some embodiments.

FIG. 14 illustrates a fan performance curve characterizing the pressure-flow rate relationship of the blower fan integrated within the radiator assembly, according to some embodiments.

FIG. 15 illustrates a top view of thermoelectric cold plate coolant system, according to some embodiments.

FIG. 16 illustrates a front view of thermoelectric cold plate coolant system, according to some embodiments.

FIG. 17 illustrates a side view of thermoelectric cold plate coolant system, according to some embodiments.

The Figures described above are a representative set and are not an exhaustive with respect to embodying the invention.

### DESCRIPTION

Disclosed are a system, method, and article of manufacture for a thermoelectric cold plate coolant system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Appendix A includes additional information for implementing various embodiments.

### DEFINITIONS

Example definitions for some embodiments are now provided.

Acrylonitrile butadiene styrene (ABS) is a common plastic polymer.

High-density polyethylene (HDPE) or polyethylene high-density (PEHD) is a polyethylene thermoplastic made from petroleum.

The thermo-electric effect is the presence of heating or cooling at an electrified junction of two different conductors. When a current is made to flow through a junction between two conductors, A and B, heat may be generated or removed at the junction. Thermo-electric cooling uses the Peltier effect to create a heat flux between the junction of two different types of materials. A thermoelectric cooler, heater, or thermoelectric heat pump is a solid-state active heat pump which transfers heat from one side of the device to the other, with consumption of electrical energy, depending on the direction of the current.

Thermal control material (TCM) is a substance with a high heat of fusion which, melting and solidifying at a certain temperature, is capable of storing and releasing large amounts of energy. Heat is absorbed or released when the material changes from solid to liquid and vice versa. Example TCM materials can include, inter alia: organic (paraffin and nonparaffin), inorganic (salt hydrates and metallic alloys), and eutectic (mixture of two or more TCM components: organic, inorganic, and both).

Polypropylene (PP) is a thermoplastic polymer used in a wide variety of applications. It is produced via chain-growth polymerization from the monomer propylene.

Press fit or friction fit is a fastening between two parts which is achieved by friction after the parts are pushed together, rather than by any other means of fastening.

Temperature sensors can include mechanical temperature sensors, electrical temperature sensors, integrated circuit sensors, medometers, etc.

Thermoelectric effect is the direct conversion of temperature differences to electric voltage and vice versa via a thermocouple. A thermoelectric device creates voltage when there is a different temperature on each side. Conversely, when a voltage is applied to it, heat is transferred from one side to the other, creating a temperature difference. At the atomic scale, an applied temperature gradient causes charge carriers in the material to diffuse from the hot side to the cold side.

6061-T6 aluminum is a precipitation-hardened aluminum alloy containing magnesium and silicon, heat-treated to the T6 temper to provide increased strength, machinability, and corrosion resistance.

3003-H14 aluminum is a work-hardened aluminum alloy containing manganese, cold-worked to the H14 temper to increase strength while retaining high thermal conductivity and corrosion resistance.

Controlled dip-coating can be a deposition process in which a part is immersed in a liquid coating bath and withdrawn at a controlled rate such that a uniform wet film forms on the surface.

Spray-deposition can be a surface-coating process that atomizes a liquid precursor and directs droplets toward a target surface to form a continuous coating layer.

A nanostructured adhesion primer layer can be a thin film comprising nanoscale features configured to promote mechanical or chemical bonding between a substrate and an overlying coating.

A hydrocarbon material layer having a thermal diffusivity can be a coating comprising organic molecules configured to exhibit a rate of internal heat transport characterized by its thermal diffusivity.

Thermal diffusivity can be a material property defined as the ratio of thermal conductivity to volumetric heat capacity (α=k/(ρ·Cp)), indicating the rate at which heat spreads through a substance.

Hydrocarbon coating mass can be a quantity of applied hydrocarbon coating material measured as the total mass present on a coated surface.

### Example Smart Refrigerator Exterior Views

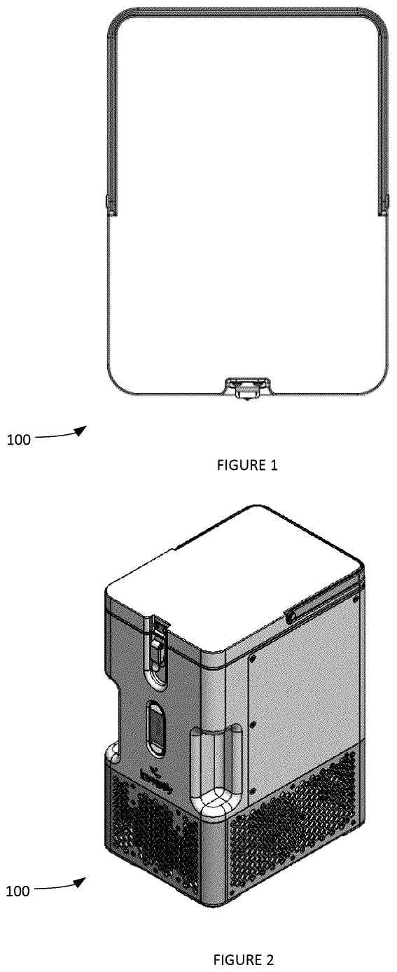

FIGS. 1-5 provide series of views of an example embodiment of a portable temperature-controlled enclosure 100, according to some embodiments. The series of views includes a set of orthographic views (e.g. top, front, side, and isometric) of the portable temperature-controlled enclosure according to one embodiment. The example embodiment of a portable temperature-controlled enclosure 100 can be a top loaded system. Portable temperature-controlled enclosure 100 can include an optimized solid-state cooling system (e.g. see infra). Portable temperature-controlled enclosure 100 provides a portable temperature-controlled enclosure utilizing an innovative solid-state cooling system with optimized thermal management. Portable temperature-controlled enclosure 100 combines advanced thermoelectric cooling technology with sophisticated control systems to achieve superior temperature stability and extended battery operation.

Portable temperature-controlled enclosure 100 comprises several key components working in concert: a precision-engineered payload chamber for storing temperature-sensitive materials, an optimized thermoelectric cooling system with angular mounting configuration, an integrated thermal control material(TCM) chamber for thermal buffering, and a sophisticated heat dissipation system including honeycomb ventilation. These components are managed by advanced monitoring and control systems, all supported by extended battery-powered operation capability.

The top-loading portable temperature-controlled enclosure 100 represents a breakthrough in portable refrigeration technology, utilizing solid-state cooling principles to maintain precise temperature control. The top-loading portable temperature-controlled enclosure 100 distinguishes itself through the complete elimination of traditional cooling infrastructure components such as compressors, refrigerant gases, cooling coils, ice packs, or gel packs.

Example physical specifications of the top-loading portable temperature-controlled enclosure 100 are now discussed. The top-loading portable temperature-controlled enclosure 100 payload capacity, by way of example, can be a one (1) liter. The top-loading portable temperature-controlled enclosure 100 can include a top-loading design with example dimensions of 107.78 mm×119.92 mm×166.84 mm.

Access to the top-loading portable temperature-controlled enclosure 100 can be via a top-mounted lid providing full access to internal chamber. Construction of The top-loading portable temperature-controlled enclosure 100 can include precision-engineered aluminum chamber with integrated cooling system.

An example Core Cooling Technology of the top-loading portable temperature-controlled enclosure 100 is now discussed. The top-loading portable temperature-controlled enclosure 100 employs an advanced solid-state cooling mechanism based on semiconductor physics. As a cooling principle, the top-loading portable temperature-controlled enclosure 100 utilizes an electron mobility differential between semiconductor materials. By way of operation, the top-loading portable temperature-controlled enclosure 100 uses an electric current passage through dual-semiconductor junction.

The thermal control during electron transition between materials is implemented to optimize cooling efficiency. The top-loading portable temperature-controlled enclosure 100 can achieve target temperature (2° C.) within 2-hour initialization period. The top-loading portable temperature-controlled enclosure 100 implements temperature maintenance to maintain 2-8° C. range for 72 hours without external power.

An example Thermal Management System of the internal payload chamber incorporates a sophisticated thermal management design. As seen below, the top-loading portable temperature-controlled enclosure 100 includes a chamber construction that includes payload 104. Here, the material composition can include a specialized heat-absorbing material combined with aluminum. The top-loading portable temperature-controlled enclosure 100 utilizes thermal spreading via an engineered aluminum structure for optimal temperature distribution. The top-loading portable temperature-controlled enclosure 100 performs heat absorption via a material matrix for thermal energy management.

The top-loading portable temperature-controlled enclosure 100 provides dynamic temperature control. Primary cooling is performed via a solid-state semiconductor chip (e.g. discussed infra). Supplementary cooling can be performed via a thermal mass buffer system. Hybrid operation between thermal mass and active cooling Response system can be used for temperature maintenance. Automated cooling bursts for temperature deviation compensation can be performed.

The top-loading portable temperature-controlled enclosure 100 can include a power and environmental adaptation power system 1102. The top-loading portable temperature-controlled enclosure 100 includes an input compatibility, by way of example of a Universal AC power (110V/220V) and an integrated charging system. Battery operation can be for 72-hour autonomous operation capability.

Optimized power consumption during steady-state operation can be obtained using bi-directional temperature control capability. For example, in a winter mode operation, the top-loading portable temperature-controlled enclosure 100 functions in extreme cold environments (−20° C. to −30° C.). Thermal management systems 1104 of the top-loading portable temperature-controlled enclosure 100 can maintains 2-8° C. in both hot and cold ambient conditions. An example environmental range enables The top-loading portable temperature-controlled enclosure 100 to be functional across extreme temperature variations.

The top-loading portable temperature-controlled enclosure 100 includes a monitoring and communication system 1106 for temperature monitoring. Real-time temperature tracking is implemented across continuous internal temperature measurement. The top-loading portable temperature-controlled enclosure 100 includes a digital display for current temperature indication. The top-loading portable temperature-controlled enclosure 100 includes an alert system for temperature deviations. The top-loading portable temperature-controlled enclosure 100 includes a communication infrastructure 1108 that can include an integrated LTE module with SIM card and/or GPS location tracking capability. The top-loading portable temperature-controlled enclosure 100 can perform data transmission intervals (e.g. at 4-5 minutes. The top-loading portable temperature-controlled enclosure 100 also includes cloud connectivity for remote monitoring. A backup SD card storage system can be included for offline data logging. The top-loading portable temperature-controlled enclosure 100 includes a Data Management module 1110 for continuous temperature logging and location tracking and recording. The top-loading portable temperature-controlled enclosure 100 can also perform automated cloud data synchronization.

The top-loading portable temperature-controlled enclosure 100 includes an Operation and Performance Temperature Performance module that manages an initial cooldown (e.g. 2 hours to reach target temperature with a temperature range: 2-8° C. maintenance and operation duration of 72 hours on battery power).

A thermal interface material utilizes a high thermal conductivity compound with controlled thickness application and full surface coverage verification. Mounting pressure can be maintained at 30-40 PSI through a spring-loaded mechanism, ensuring even pressure distribution across the chip surface and compensation for thermal expansion and contraction in some example embodiments.

The top-loading configuration represents a significant advancement in portable temperature-controlled storage, combining innovative solid-state cooling technology with sophisticated thermal management and monitoring systems. The design achieves exceptional efficiency and reliability while maintaining precise temperature control across varied environmental conditions.

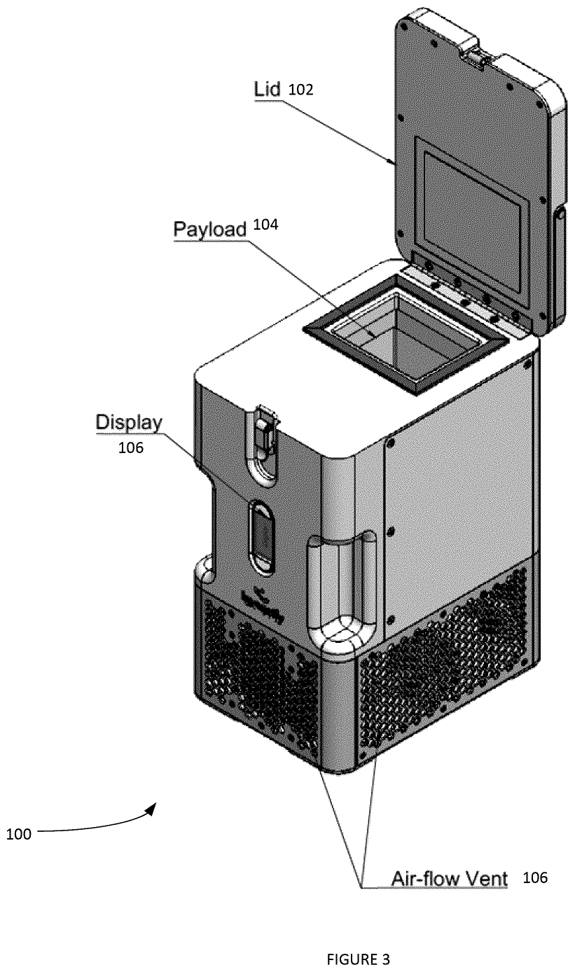

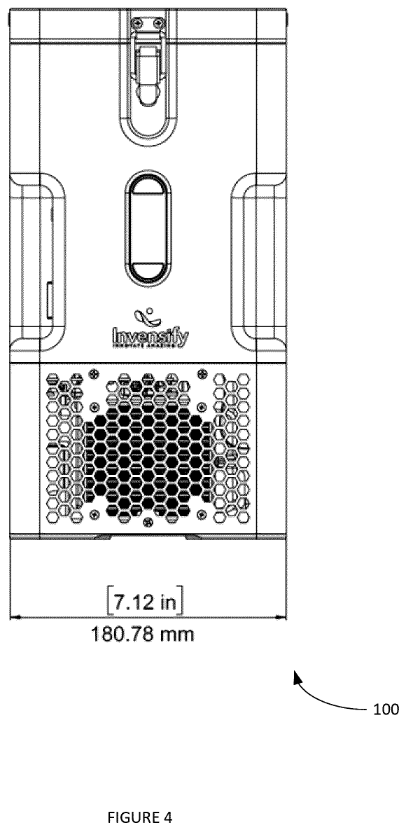

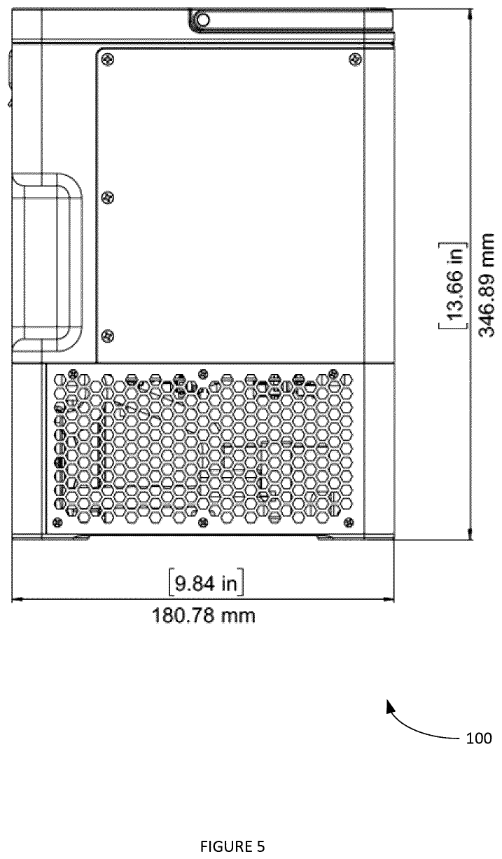

More specifically, FIG. 1 is a top view of example embodiment of a portable temperature-controlled enclosure 100, according to some embodiments. FIGS. 2 and 3 are isometric views of example embodiment of a portable temperature-controlled enclosure 100, according to some embodiments. FIG. 4 is a front view of example embodiment of a portable temperature-controlled enclosure 100, according to some embodiments. FIG. 5 is a side view of example embodiment of a portable temperature-controlled enclosure 100, according to some embodiments.

In one embodiments, portable temperature-controlled enclosure 100 can have a top-loading configuration with example payload dimensions: 3.2″×4.1″×5.5″. An example top opening capacity can be one (1) liter. Overall dimensions, by way of example, can be 107.78 mm×119.92 mm×166.84 mm. Portable temperature-controlled enclosure 100 provides a top access lid for payload (e.g. medications, etc.) insertion.

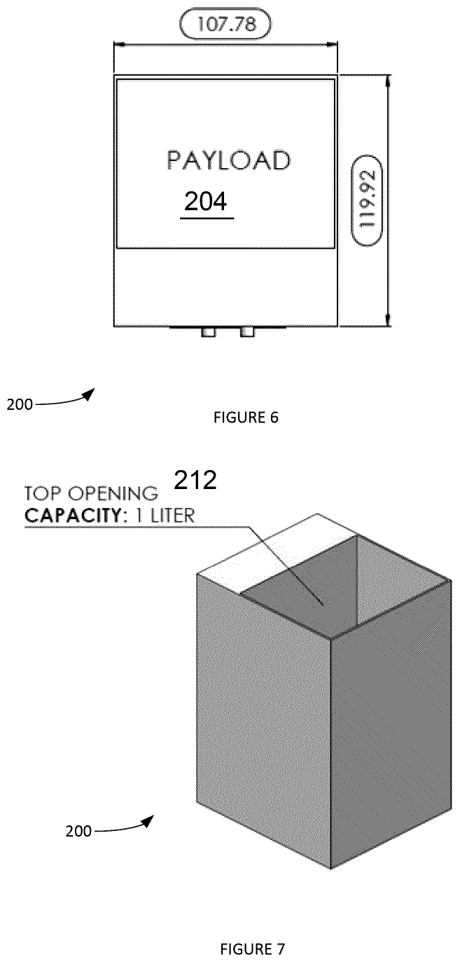

FIG. 6-9 illustrate various example views of an aluminum cooling chamber portable unit 200, according to some embodiments. Aluminum cooling chamber portable unit 200 can be the internal cooling/heating system of portable temperature-controlled enclosure 100.

Aluminum cooling chamber portable unit 200 of portable temperature-controlled enclosure 100 comprises a sophisticated thermoelectric cooling mechanism wherein electrical power is transmitted through a strategically positioned semiconductor chip 202 mounted at a calculated angular orientation relative to the aluminum payload chamber 204. The semiconductor chip 202 incorporates a material combination wherein electrons traverse between different semiconductor elements, creating an thermal control effect at the material junction interfaces. This thermal control phenomenon, occurring at the precise locations where the material composition transitions, facilitates the cooling process through electron mobility differentials between the semiconductor materials.

The thermal management system utilizes direct thermal coupling between the semiconductor chip 202 and an aluminum payload chamber 204, whereby the thermal control at the material junctions actively extracts heat from the payload area through the aluminum wall interface. The extracted thermal energy is subsequently transferred to a closed-loop cooling system 206 comprising fluid-carrying pipes 208 directly coupled to the posterior surface of the semiconductor chip (e.g. can include a heat sink system). The cooling loop 206 employs either water or antifreeze as the working fluid, circulating through an engineered pipe network via an integrated pump mechanism.

The system's thermal circuit can be completed through a fan-assisted heat exchanger configuration 214, wherein the heated working fluid from the cooling loop 206 is actively cooled before being recirculated through the system. The angular mounting of the semiconductor chip, deliberately oriented at a calculated angle rather than perpendicular to the payload chamber, achieves enhanced cooling distribution by optimizing the radius of coolness spread and increasing the effective surface area coverage. This angular configuration demonstrably improves the speed and uniformity of temperature distribution compared to traditional perpendicular mounting arrangements.

The thermal control system can operate in a dual-power configuration, initially utilizing wall power for the cooldown phase until the target temperature (typically 2° C.) is achieved, at which point the system transitions to battery power through a lithium polymer battery assembly capable of maintaining temperature control for 72 hours of autonomous operation. The internal configuration includes various top-loading variants (e.g. via top opening 212, etc.) while maintaining identical operational principles, with the semiconductor chip positioning optimized for each configuration to maximize cooling efficiency through enhanced radial distribution patterns.

The angular orientation of the semiconductor chip 202 relative to the payload chamber wall facilitates superior thermal spreading characteristics. The cooling effect disperses in a radial pattern rather than traditional linear distribution, resulting in more efficient coverage of the payload surface area and accelerated temperature equalization throughout the chamber. This geometric optimization of the semiconductor chip 202 placement enables the system to achieve more comprehensive thermal coverage compared to conventional perpendicular mounting configurations, as the angular positioning creates an expanded radius of cooling influence that enhances the overall heat absorption efficiency of the system.

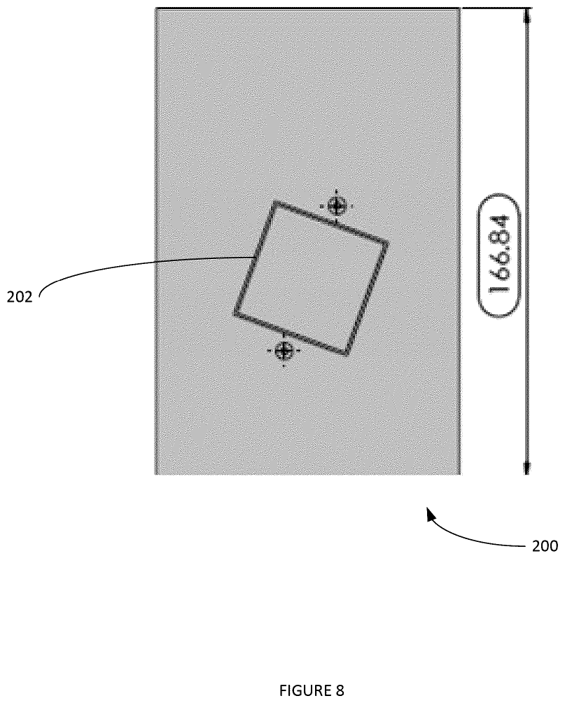

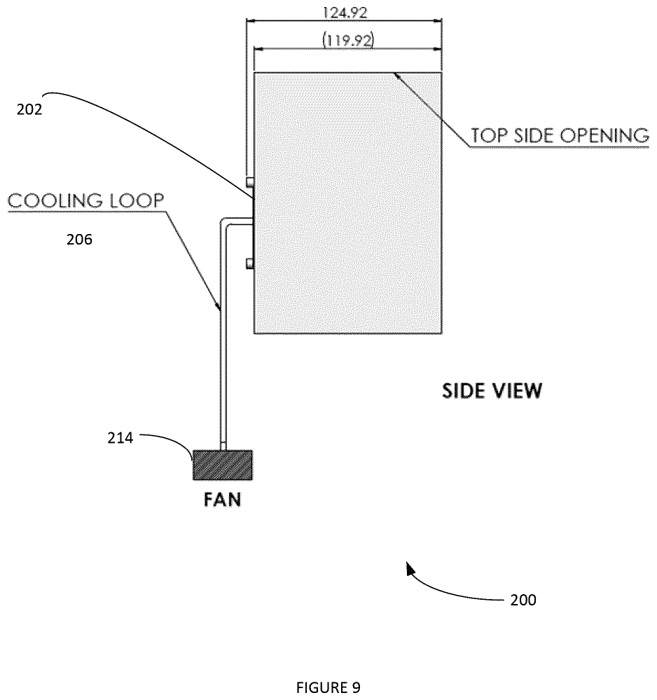

More specifically, FIG. 6 illustrates a top-view of aluminum cooling chamber portable unit 200, according to some embodiments. FIG. 7 illustrates a isometric-view of aluminum cooling chamber portable unit 200, according to some embodiments. FIG. 8 illustrates a rear-view of aluminum cooling chamber portable unit 200, according to some embodiments. FIG. 9 illustrates a side-view of aluminum cooling chamber portable unit 200, according to some embodiments.

### Example Computer Architecture and Systems

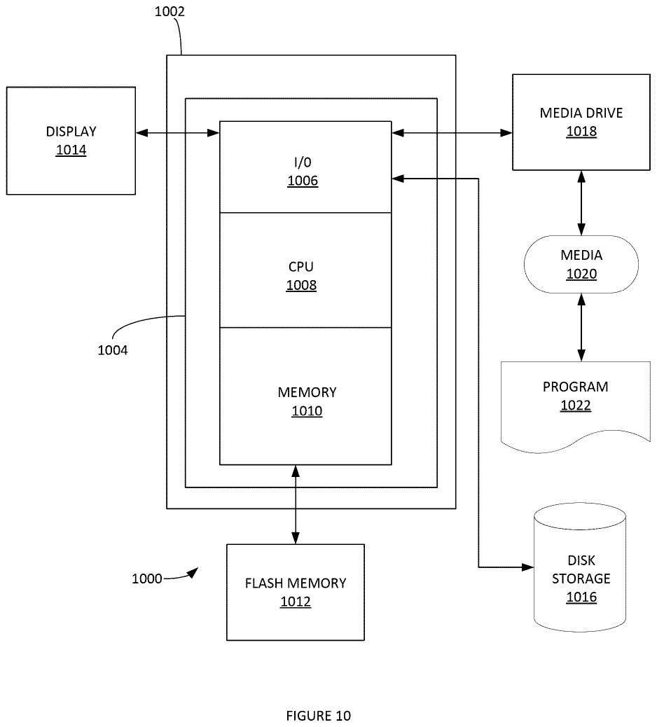

FIG. 10 depicts an exemplary computing system 1000 that can be configured to perform any one of the processes provided herein. In this context, computing system 1000 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Thermo-electric cooler pump can be managed by a computing system in the portable smart refrigerator. The computing system can be coupled with an exterior display. Exterior display can display various parameters (e.g. temperature, battery power, etc.) of the portable smart refrigerator. Computing system can also be coupled with various other systems such as, inter alia: temperature sensors, digital clocks, Wi-Fi systems, etc.

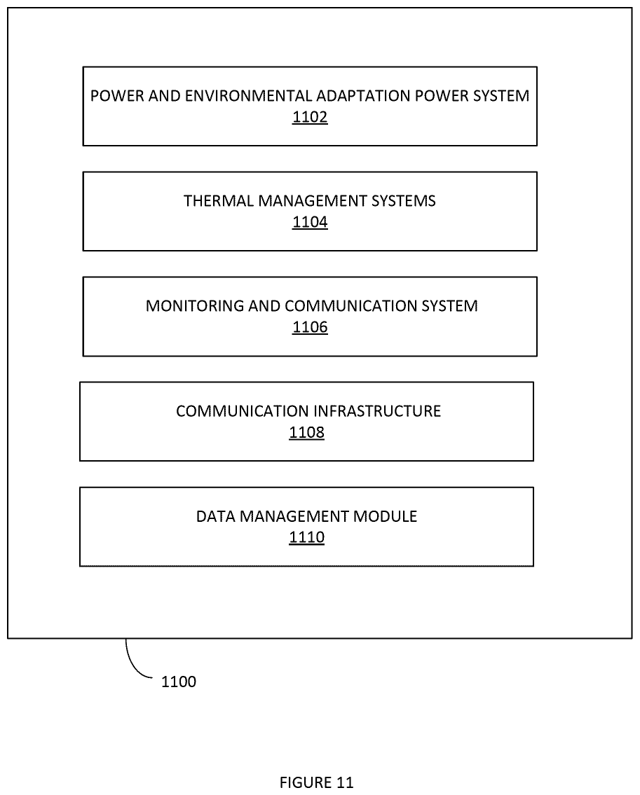

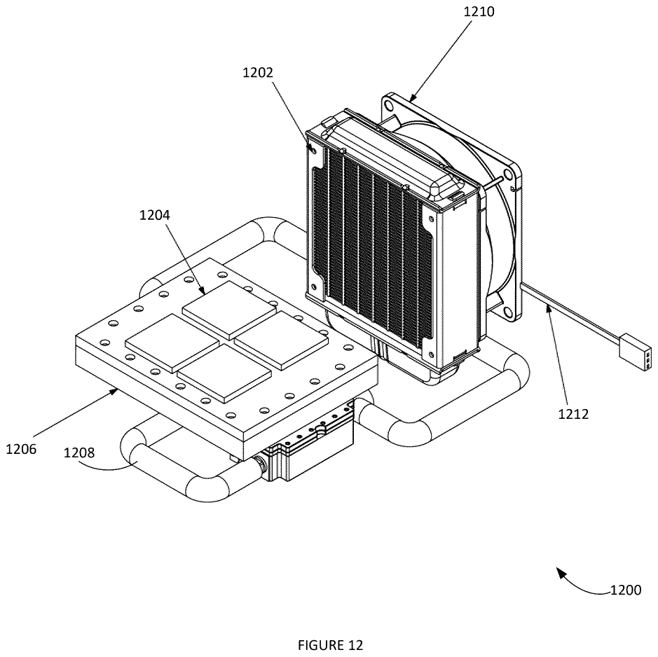

FIG. 11 illustrates a logical view 1100 of a portable temperature-controlled enclosure, according to some embodiments. Power and environmental adaptation power system 1102. The top-loading portable temperature-controlled enclosure 100 includes an input compatibility, by way of example of a Universal AC power (110V/220V) and an integrated charging system. Thermal management systems 1104 manage the temperature of top-loading portable temperature-controlled enclosure 100. Thermal management systems 110 of the top-loading portable temperature-controlled enclosure 100 can maintain 2-8° C. in both hot and cold ambient conditions. Monitoring and communication system 1106 for temperature monitoring. Real-time temperature tracking is implemented across continuous internal temperature measurement. The top-loading portable temperature-controlled enclosure 100 includes a digital display for current temperature indication. The top-loading portable temperature-controlled enclosure 100 includes an alert system for temperature deviations. The top-loading portable temperature-controlled enclosure 100 includes a communication infrastructure 1108 that can include an integrated LTE module with SIM card and/or GPS location tracking capability. The top-loading portable temperature-controlled enclosure 100 can perform data transmission intervals (e.g. at 4-5 minutes. The top-loading portable temperature-controlled enclosure 100 also includes cloud connectivity for remote monitoring. A backup SD card storage system can be included for offline data logging. The top-loading portable temperature-controlled enclosure 100 includes a Data Management module 1110 for continuous temperature logging and location tracking and recording.

Additional information on chip positioning is now discussed. The innovative cooling system centers around a precisely engineered 40 mm×40 mm semiconductor chip that represents a significant advancement in portable refrigeration technology. This chip, comprising multiple semiconductor junctions arranged in an optimized pattern, is mounted at a carefully calculated 20-degree angle relative to the payload chamber wall, deviating from traditional perpendicular mounting approaches. This specific angular orientation was chosen to maximize the cooling efficiency through enhanced radial distribution patterns.

The mounting configuration creates a sophisticated thermal management system where the chip interfaces directly with the aluminum chamber wall for maximum thermal conductivity. This direct coupling is maintained by a spring-loaded mechanism that ensures a consistent 30-40 PSI mounting pressure, crucial for optimal heat transfer. The interface between the chip and wall utilizes a high thermal conductivity compound with carefully controlled thickness and verified full surface coverage.

The 20-degree mounting angle serves a critical purpose in the system's operation. Unlike conventional perpendicular mounting, which typically results in linear cooling distribution, this angular orientation creates an expanded radius of cooling influence. This radial distribution pattern enables more comprehensive coverage of the payload surface area and facilitates faster temperature equalization throughout the chamber. The result is a more efficient and effective cooling system that achieves superior thermal coverage compared to traditional mounting configurations.

In the top-loaded configuration, the chip is positioned lower, near the midsection of the wall, with the temperature sensor strategically placed inside the payload wall towards the bottom side. This positioning was specifically chosen to optimize the cooling effect in relation to the temperature sensor location. The entire setup demonstrates a carefully engineered approach to thermal management, where each component's position has been optimized for maximum efficiency.

The semiconductor chip's design and mounting create a cooling effect that disperses in a radial pattern rather than a traditional linear distribution. This radial dispersion is particularly effective because it provides more uniform coverage across the payload area. The angular mounting effectively increases the total area over which the cooling effect spreads, resulting in more efficient temperature control throughout the chamber. This innovative approach to chip mounting and cooling distribution represents a significant advancement in portable refrigeration technology, offering improved performance over conventional perpendicular mounting systems.

The system's overall design reflects a deep understanding of thermal dynamics and practical engineering considerations. By combining the precise 40 mm×40 mm chip dimensions with the 20-degree mounting angle and strategic positioning relative to temperature sensors, the system achieves optimal cooling performance while maintaining efficient use of space within the portable unit. The careful attention to mounting pressure, thermal compound application, and interface design ensures reliable and consistent performance, making this cooling system particularly well-suited for portable applications requiring precise temperature control.

Example embodiments of a Thermoelectric Cold Plate Coolant System are now discussed. This invention provides an integrated cooling solution that incorporates thermoelectric cooler (TEC) designs into a comprehensive heat dissipation system, forming a modular thermal management platform capable of efficiently managing substantial thermal loads in a compact form factor.

The system consists of a cold plate, preferably constructed from copper or aluminum, which serves as the primary heat absorber and coolant distribution manifold. In the preferred embodiment, the cold plate is substantially square in configuration with dimensions of approximately 80 mm×80 mm, though other geometric configurations are within the scope of this invention. Four thermoelectric cooling chips are mounted on top of this cold plate, though alternative embodiments may utilize two, three, or more than four chips depending on the thermal load requirements. The cold plate is quite thin, approximately 1 mm in thickness, enabling compact integration while maintaining structural integrity and thermal performance.

Each thermoelectric cooling chip comprises a plurality of semiconductor pellet pairs arranged between conductive traces. In one embodiment, each chip measures approximately 20 mm×20 mm and contains 128 pairs of semiconductor pellets, with each pellet measuring approximately 1 mm×1 mm×1 mm with a gap of approximately 0.25 mm between adjacent pellets. In an alternative embodiment optimized for different performance characteristics, each chip contains 50 pairs of larger semiconductor pellets while maintaining the same overall chip dimensions. The semiconductor pellets are preferably composed of bismuth telluride, though other thermoelectric materials known in the art may be substituted. The conductive traces connecting the pellets are preferably copper with a thickness of approximately 0.05 mm, and top and bottom ceramic plates with a thickness of approximately 0.2 mm provide electrical insulation and structural support.

The thermoelectric chips are affixed to the cold plate surface through soldering or other thermally conductive bonding methods. When electrical current is applied to the thermoelectric chips, electron mobility differentials at the junction between the semiconductor pellets and the conductive traces create a thermoelectric cooling effect, whereby thermal energy is absorbed at the top surface of each chip. This absorbed heat is transferred through the chip structure to the bottom surface, where it is conducted into the cold plate body. Any heat-generating component placed in thermal contact with the top surfaces of the thermoelectric chips will thus experience active cooling.

The cold plate body contains a network of internal channels through which a liquid coolant, preferably water or water-based antifreeze solution, continuously circulates. This coolant absorbs the thermal energy conducted into the cold plate from the thermoelectric chips and carries it away from the cold plate through a tube outlet. The heated coolant is then pumped through a radiator assembly equipped with a blower fan that facilitates convective heat dissipation into the ambient air. Once cooled, the liquid returns to the cold plate via a tube inlet to complete the circulation loop.

A pump maintains continuous coolant circulation throughout the closed-loop system. The pump is powered through a connected power cable, which also provides electrical power to the thermoelectric chips and the blower fan. The entire assembly thus forms an integrated, modular cooling system that can be incorporated into various applications requiring precision thermal management.

In the preferred embodiment, the radiator assembly comprises a finned heat exchanger with multiple heat pipes embedded within the fin structure to enhance heat distribution. Technical specifications for the optimized radiator configuration indicate the system can handle a total thermal load of 100 W, with each heat pipe carrying approximately 25 W of thermal power, when operating at an ambient air temperature of 25° C. The blower fan operates at 5200 RPM in the optimized configuration, providing sufficient airflow to maintain thermal equilibrium under maximum load conditions. Performance characterization includes pressure-flow rate curves demonstrating the fan's operational envelope across different static pressure and airflow conditions.

The system design can be optimized through comprehensive computational fluid dynamics (CFD) simulations analyzing four different radiator design variations. The simulation studies systematically vary fin thickness (ranging from 0.3 mm to 0.4mm), fin pitch (ranging from 1.25 mm to 1.5mm), fan speeds (ranging from 3200 RPM to 5200 RPM), and heat pipe configurations (ranging from 4 to 6 heat pipes penetrating through the fin array). Airflow visualization studies reveal the velocity profiles and thermal distribution patterns across these different designs, enabling identification of the optimal configuration.

This thermoelectric cold plate coolant system represents a novel integration of solid-state thermoelectric cooling technology with liquid coolant circulation and forced-air heat dissipation. The modular design enables incorporation into diverse thermal management applications, including but not limited to portable temperature-controlled enclosures, electronic component cooling, medical sample storage, and precision climate control systems. The compact form factor, combined with the absence of compressor-based refrigeration components, provides advantages in weight, reliability, and energy efficiency compared to conventional cooling approaches.

The following discussion addresses the novel aspects of the present invention and distinguishes the invention from prior art thermoelectric cooling systems. The present invention represents a significant departure from conventional thermoelectric cooling system architectures through the direct integration of solid-state thermoelectric cooling devices with a thin-profile liquid-cooled cold plate. Prior art thermoelectric cooling systems typically employ air-cooled heat sinks attached to the hot side of thermoelectric devices, or alternatively utilize separate liquid cooling loops that are mechanically coupled to the thermoelectric devices through thermal interface materials and mounting hardware. In contrast, the present invention directly affixes the thermoelectric cooling chips to the top surface of a cold plate body containing internal coolant circulation channels, creating a unified thermal management module. This integration achieves several technical advantages over prior art approaches. First, the direct thermal coupling between the thermoelectric devices and the liquid-cooled substrate eliminates multiple thermal resistance layers present in conventional mounting approaches (e.g., thermal interface materials, mechanical fasteners, air gaps, etc.). Second, the thin-profile cold plate (approximately 1 mm thickness) enables a compact overall system volume while maintaining high heat flux capacity through the internal coolant channels. Third, the modular architecture separates the thermal management function from the end-use application, enabling the cold plate assembly to be incorporated into diverse systems without modification to the core cooling components. The achievement of 100 W thermal load capacity in a compact form factor measuring approximately 80 mm×80 mm×1 mm for the cold plate, plus radiator assembly, represents state-of-the-art volumetric power density for solid-state cooling systems. Prior art thermoelectric systems of comparable capacity typically require significantly larger air-cooled heat sink volumes or employ bulky liquid cooling loops with external heat exchangers.

The thermoelectric cooling chips in the present invention are permanently affixed to the cold plate surface through soldering or thermally conductive adhesive bonding, rather than being mechanically clamped or pressure-mounted as is typical in prior art thermo-electric cooling assemblies. This direct bonding approach eliminates the thermal interface resistance associated with thermal greases, phase-change materials, or elastomeric thermal pads that are conventionally employed between thermoelectric devices and heat sinks. Prior art thermoelectric cooling systems generally utilize removable or serviceable thermoelectric modules mounted with mechanical fasteners and thermal interface materials. While this approach facilitates field replacement of failed thermoelectric devices, it introduces thermal resistance at the interface that degrades overall system performance. The present invention accepts the trade-off of permanent device integration in exchange for superior thermal coupling and improved reliability through elimination of mechanical failure modes (e.g., fastener loosening, thermal interface material pump-out, mounting pressure loss over thermal cycles, etc.). The direct soldering approach also enables more uniform thermal contact across the entire interface area compared to mechanical mounting methods, which can suffer from non-uniform pressure distribution or surface planarity deviations. This uniform thermal coupling is particularly important when multiple thermoelectric chips are mounted on a single cold plate, as in the four-chip configuration of the preferred embodiment, to ensure balanced heat extraction across all devices.

The present invention encompasses thermoelectric cooling chips with two distinct pellet density configurations: a 128-pair configuration with smaller pellets (approximately 0.5 mm×0.5 mm×0.5mm) and a 50-pair configuration with larger pellets (approximately 1 mm×1 mm×1mm). Both configurations occupy the same overall chip footprint (approximately 20 mm×20mm), enabling direct substitution without modification to the cold plate or system architecture. These alternative chip architectures provide different performance characteristics optimized for different operational requirements. The 128-pair configuration with higher pellet density provides finer temperature control granularity and improved coefficient of performance under partial-load conditions, making it suitable for applications requiring precise temperature regulation or variable thermal loads. The 50-pair configuration with larger pellets offers higher current handling capacity and improved efficiency under high-flux conditions, making it preferable for applications with sustained maximum thermal loads. This modular approach to thermoelectric chip specification represents a flexible design methodology not commonly employed in prior art thermoelectric cooling systems, which typically utilize fixed-configuration devices optimized for a narrow operational envelope. The ability to select between alternative chip architectures during system design or manufacturing, without modifying other system components, provides significant advantages in customizing thermal management solutions for diverse applications while maintaining economies of scale in cold plate and radiator assembly production.

The radiator assembly in the present invention can be systematically optimized through computational fluid dynamics analysis of multiple design parameters (e.g., fin thickness, fin pitch, fan speed, heat pipe configuration, etc.). This comprehensive multi-parameter optimization approach differs from conventional radiator design methodologies that typically optimize individual parameters in isolation or rely primarily on empirical testing. The CFD analysis evaluates four distinct radiator configurations under standardized test conditions (100 W thermal load, 25° C. ambient temperature), revealing that thermal resistance can be improved by 45% through synergistic optimization of multiple design variables. The optimal configuration identified through this analysis combines 0.4 mm fin thickness, 1.5 mm fin pitch, 5200 RPM fan speed, and 6 heat pipes penetrating through the fin structure, achieving a thermal resistance of 0.1001° C./W. This systematic optimization methodology provides several advantages over prior art radiator design approaches. First, the CFD analysis reveals non-obvious interactions between design parameters; for example, the optimal fin pitch depends on both fin thickness and fan speed, and these relationships cannot be determined through single-parameter optimization. Second, the computational approach enables evaluation of a large design space more efficiently than empirical testing would permit. Third, the airflow visualization capabilities of CFD analysis provide insights into flow patterns and thermal distributions that guide design refinement beyond what temperature measurements alone would reveal. The resulting radiator configuration achieves performance representing the state of the art for compact forced-air heat exchangers in this size class, enabling the overall thermoelectric cold plate coolant system to manage 100 W thermal loads while maintaining compact system dimensions suitable for portable and space-constrained applications.

The present invention employs single-phase liquid circulation throughout the closed cooling loop, wherein the coolant remains in liquid phase during normal operation and heat transfer occurs through sensible heating of the liquid rather than through latent heat of vaporization. This architectural choice distinguishes the present invention from heat pipe or vapor chamber cooling systems that exploit phase-change heat transfer. While phase-change cooling systems are well established in the prior art and offer high effective thermal conductivity through vapor transport, they also present several operational limitations that the present invention avoids. Heat pipes are subject to wick structure limitations that constrain maximum heat flux and impose orientation dependencies. Vapor chambers require careful working fluid charge management and can suffer from dry-out failure modes under overload conditions. Phase-change systems are also limited in maximum heat transport capacity by vapor flow dynamics and pressure drop considerations. The single-phase liquid cooling architecture of the present invention provides several operational advantages: elimination of wick structures and associated capillary limitations enables orientation-independent operation; maximum thermal load capacity can be increased by raising coolant flow rate rather than being fundamentally limited by vapor transport physics; system architecture is simplified through elimination of vapor/liquid separation requirements; and reliability is improved through elimination of working fluid charge loss or dry-out failure modes that can affect phase-change systems. The combination of thermoelectric cooling devices with single-phase liquid cooling in an ultra-thin cold plate configuration represents a novel system architecture that achieves the benefits of liquid cooling (e.g., high heat flux capacity, compact heat source coupling, etc.) while avoiding the complexities and limitations of phase-change systems, and while retaining the advantages of solid-state thermo-electric cooling (e.g., precise temperature control, silent operation, unlimited orientation capability, etc.).

The thermoelectric cold plate coolant system of the present invention functions as a modular thermal management platform that can be incorporated into diverse end-use applications without modification to the core cooling components. This platform approach separates the thermal management function into a standalone module that is specified and optimized independently of the particular application, whether that be portable temperature-controlled enclosures, electronic component cooling, medical sample storage systems, or other precision climate control applications. Prior art thermoelectric cooling systems are typically designed as application-specific assemblies with integrated payload chambers, electronic heat sources, or other application-specific elements. The design, optimization, and manufacturing of the cooling system is thus tightly coupled to the particular end-use application, limiting economies of scale and requiring substantial redesign effort when adapting the technology to new applications. The modular architecture of the present invention enables several advantages over application-specific designs. Manufacturing economies of scale can be achieved by producing standardized cold plate assemblies and radiator configurations that serve multiple end-use markets. System design complexity is reduced by establishing clear thermal and mechanical interfaces between the thermal management module and the application-specific components. Performance optimization of the cooling module can proceed independently of application development, enabling more thorough characterization and validation. Field service and warranty management is simplified when the thermal management module is a discrete replaceable assembly. This platform approach to thermal management system design represents a significant departure from conventional practice in thermoelectric cooling systems and enables more efficient development and deployment of thermal management solutions across diverse applications requiring compact, high-performance temperature control.

The thermoelectric cold plate coolant system achieves volumetric power density exceeding 0.8 W/cm³ while operating exclusively with solid-state thermoelectric devices and without compressor-based refrigeration components, rotary refrigerant compressors, or vapor-compression cycles. This performance represents a significant advancement over prior art thermoelectric cooling systems, which typically suffer from poor volumetric efficiency due to over-sized heat sink requirements or inadequate heat extraction from the hot side of thermoelectric devices. The achievement of high volumetric power density in a solid-state cooling system provides several practical advantages. Portable and battery-powered applications benefit from reduced weight and volume compared to compressor-based refrigeration systems. Silent operation is inherent to solid-state cooling, unlike compressor systems that generate acoustic noise. Orientation independence enables use in any mounting configuration without performance degradation, unlike compressor systems that may have orientation constraints. Precise temperature control is facilitated by the linear relationship between thermoelectric cooling power and electrical current, enabling simple and responsive temperature regulation. The absence of refrigerant gases eliminates environmental concerns and regulatory compliance requirements associated with vapor-compression refrigeration systems. By integrating liquid cooling with optimized radiator design and direct chip bonding, the present invention achieves thermal performance approaching that of compressor-based systems while retaining all of the inherent advantages of solid-state operation. This performance level represents a critical threshold for enabling solid-state thermoelectric technology to compete effectively with conventional refrigeration in portable and space-constrained applications where the advantages of solid-state cooling provide significant value.

Beyond the individual novel elements described above, the present invention achieves its overall performance through the synergistic integration of multiple design innovations into a coherent system architecture. The ultra-thin cold plate enables compact integration, but only achieves its full potential when combined with direct chip bonding to minimize thermal resistance. The CFD-optimized radiator provides efficient heat dissipation, but only enables high system-level performance when coupled with the high heat flux extraction capability of the liquid-cooled cold plate. The alternative thermoelectric chip architectures provide application-specific optimization, but only deliver practical benefits within a modular platform architecture that enables chip substitution without system redesign. This synergistic integration of multiple innovations into a unified thermal management system represents the essential inventive contribution that distinguishes the present invention from prior art approaches that might employ individual elements (e.g., thermoelectric cooling, liquid cooling, optimized heat sinks, etc.) in isolation but fail to achieve the performance, compactness, and versatility that emerges from their thoughtful integration.

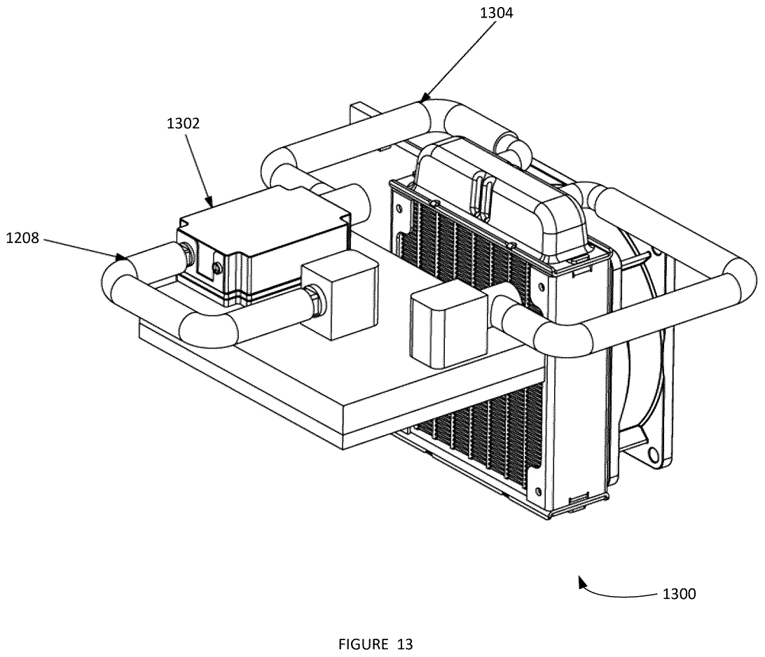

FIG. 12 illustrates an exploded view of the thermoelectric cold plate coolant system assembly 1200, according to some embodiments. Thermoelectric cold plate coolant system assembly 1200 shows the spatial relationship and interconnection between the primary components.

Thermoelectric cold plate coolant system assembly 1200 comprises a cold plate 1204 having a substantially square configuration with dimensions of approximately 80 mm×80 mm and a thickness of approximately 1 mm, wherein the cold plate body contains internal coolant circulation channels formed within the cold plate structure to facilitate efficient heat transfer from the thermoelectric devices to the circulating liquid coolant. Cold plate 1204 is preferably constructed from copper or aluminum to provide high thermal conductivity and mechanical stability.

Four thermoelectric cooling chips 1206 are affixed to the top surface of cold plate 1204 through soldering or thermally conductive adhesive bonding, with each thermoelectric chip measuring approximately 20 mm×20 mm and comprising a plurality of semiconductor pellet pairs arranged between electrically conductive copper traces. In one embodiment, each thermoelectric chip 1206 contains 128 pairs of bismuth telluride semiconductor pellets, with each pellet measuring approximately 1 mm×1 mm×1 mm and separated by gaps of approximately 0.25 mm, while an alternative embodiment employs 50 pairs of larger semiconductor pellets within the same chip footprint to provide different performance characteristics optimized for varying thermal load conditions. The direct bonding of thermoelectric chips 1206 to cold plate 1204 eliminates thermal interface resistance and ensures uniform thermal contact across the entire interface area.

Cold plate 1204 is fluidly connected to a radiator assembly 1202 through a coolant outlet tube 1210 and a coolant inlet tube 1208, forming a closed-loop coolant circulation path wherein liquid coolant remains in liquid phase throughout normal operation without undergoing phase change. Coolant outlet tube 1210 carries heated liquid coolant from the internal channels of cold plate 1204 to radiator assembly 1202 after the coolant has absorbed thermal energy conducted into the cold plate from thermoelectric chips 1206, while coolant inlet tube 1208 returns cooled liquid coolant from radiator assembly 1202 back to cold plate 1204, thereby completing the circulation loop.

Radiator assembly 1202 comprises a finned heat exchanger structure with multiple heat pipes embedded within the fin array, wherein the heat exchanger is configured to dissipate thermal energy from the heated coolant into ambient air through forced convection facilitated by an integrated blower fan. In the optimized configuration, radiator assembly 1202 incorporates fins having a thickness of approximately 0.4 mm with a fin pitch of approximately 1.5 mm, and includes six heat pipes penetrating through the fin structure, with each heat pipe capable of transferring approximately 25 W of thermal power. The blower fan operates at approximately 5200 RPM to provide sufficient airflow to maintain thermal equilibrium under maximum load conditions, enabling the system to handle a total thermal load of 100 W when operating at an ambient air temperature of 25° C. The radiator configuration achieves a thermal resistance of approximately 0.1001° C./W, representing a 45% improvement over baseline designs through synergistic optimization of fin geometry, fan speed, and heat pipe configuration.

A power cable 1212 provides electrical power to thermoelectric cooling chips 1206, a coolant circulation pump not visible in this view, and the blower fan integrated within radiator assembly 1202. The pump maintains continuous single-phase liquid circulation throughout the closed-loop system at a flow rate sufficient to extract heat from the thermoelectric devices while avoiding pressure drops that would compromise system performance.

The modular configuration illustrated in FIG. 12 demonstrates the separation between the thermal management module comprising cold plate 1204 and thermoelectric chips 1206 and the heat dissipation subsystem comprising radiator assembly 1202, enabling incorporation of the system into diverse end-use applications including portable temperature-controlled enclosures, electronic component cooling, medical sample storage systems, and precision climate control applications without modification to the core cooling components. The system achieves volumetric power density exceeding 0.8 W/cm³ while operating exclusively with solid-state thermoelectric devices without compressor-based refrigeration components, rotary refrigerant compressors, or vapor-compression cycles.

FIG. 13 illustrates an alternative perspective view of the thermoelectric cold plate coolant system assembly 1300, according to some embodiments. Thermoelectric cold plate coolant system assembly 1300 shows the same integrated cooling system as FIG. 12 from a rotated angular orientation that emphasizes the underside of the cold plate module and the spatial arrangement of the interconnected components.

Assembly 1300 comprises a cold plate visible from its underside perspective, showing the external surface of the cold plate body and demonstrating the thin-profile design with an approximate thickness of 1 mm. The cold plate has a substantially square configuration with dimensions of approximately 80 mm×80 mm, and contains internal coolant circulation channels not visible in this view. Four thermoelectric cooling chips are affixed to the opposite top surface of the cold plate not visible in this view, wherein each thermoelectric chip measures approximately 20 mm×20 mm and comprises a plurality of semiconductor pellet pairs arranged between electrically conductive copper traces.

The cold plate is fluidly connected to a radiator assembly positioned at the upper portion of the view through a coolant outlet tube and a coolant inlet tube that form a closed-loop coolant circulation path. The coolant outlet tube carries heated liquid coolant from the internal channels of the cold plate to the radiator assembly after the coolant has absorbed thermal energy conducted into the cold plate from the thermoelectric chips on the opposite surface. The coolant inlet tube returns cooled liquid coolant from the radiator assembly back to the cold plate to complete the circulation loop. The tube routing follows curved paths to accommodate thermal expansion and provide mechanical flexibility while maintaining leak-tight connections, and the routing avoids sharp bends that could restrict flow or create excessive pressure drop in the system.

The radiator assembly shown at the top of the view comprises a finned heat exchanger structure with the fin array visible as the corrugated section configured to maximize surface area for convective heat transfer. The radiator assembly incorporates multiple heat pipes embedded within the fin structure, with the fins oriented to optimize airflow distribution when forced air is provided by an integrated blower fan. In the optimized configuration, the radiator assembly incorporates fins having a thickness of approximately 0.4 mm with a fin pitch of approximately 1.5 mm, and includes six heat pipes penetrating through the fin structure. The radiator housing provides structural support and directs airflow through the fin array to achieve a thermal resistance of approximately 0.1001° C./W when dissipating a 100 W thermal load at an ambient temperature of 25° C.

A coolant circulation pump maintains continuous single-phase liquid circulation throughout the closed-loop system at a flow rate sufficient to extract heat from the thermoelectric devices while avoiding pressure drops that would compromise system performance. The pump can be positioned along the tube routing or integrated with the cold plate or radiator assembly to minimize overall system footprint while ensuring adequate flow distribution to the internal channels of the cold plate.

The perspective view illustrated in FIG. 13 demonstrates the compact three-dimensional integration of components and shows how the ultra-thin cold plate, curved tube routing, and radiator assembly combine to create a modular thermal management platform. The spatial arrangement visible in this view achieves volumetric power density exceeding 0.8 W/cm³ while maintaining necessary clearances for thermal expansion, vibration isolation, and serviceability of fluidic connections. The tube routing and component arrangement support operation in multiple orientations, consistent with the single-phase liquid cooling architecture that eliminates orientation dependencies associated with phase-change cooling systems. The modular configuration enables the cold plate assembly to be integrated into diverse end-use applications including portable temperature-controlled enclosures, electronic component cooling, medical sample storage systems, and precision climate control applications without modification to the core cooling components, while the radiator assembly can be positioned remotely if needed for optimal airflow access or spatial constraints.

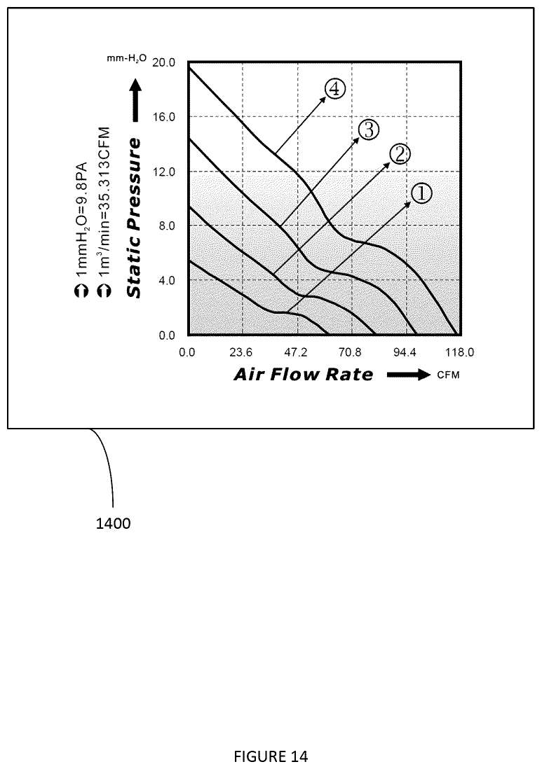

FIG. 14 illustrates a fan performance curve 1400 characterizing the pressure-flow rate relationship of the blower fan integrated within the radiator assembly, according to some embodiments. Fan performance curve 1400 provides essential data for system design optimization and demonstrates the operational capabilities of the forced-air cooling subsystem across varying static pressure and airflow conditions.

The graph comprises a vertical axis representing static pressure measured in millimeters of water column ranging from 0.0 to 20.0 mm-H₂O, and a horizontal axis representing air flow rate measured in cubic feet per minute ranging from 0.0 to 118.0 CFM. Four distinct performance curves labeled 1, 2, 3, and 4 are plotted on the graph, each representing different fan operating conditions corresponding to different rotational speeds of the blower fan. The curves demonstrate the inverse relationship between static pressure capability and volumetric airflow delivery, wherein increased airflow rate results in decreased static pressure that the fan can overcome.

Curve 4 represents the highest performance operating condition, providing maximum static pressure capability across all flow rates with approximately 20.0 mm-H₂O at zero flow conditions. Curve 3 represents an intermediate performance level between curves 4 and 2. Curve 2 represents a lower intermediate performance level between curves 3 and 1. Curve 1 represents the lowest performance operating condition with maximum static pressure of approximately 10 to 11 mm-H₂O at zero flow conditions. The multiple curves enable selection of appropriate fan speed to balance thermal performance requirements against power consumption and acoustic noise generation.

The shaded region beneath the performance curves represents the operational envelope within which the blower fan can produce combinations of static pressure and volumetric flow rate. Operating points falling outside this envelope exceed the fan's capabilities and cannot be sustained. The actual operating point of the fan in the installed system configuration is determined by the intersection of the fan performance curve with the system resistance curve, wherein the system resistance is determined by the pressure drop through the radiator fin array, coolant tubes, and any other flow restrictions in the airflow path.

In the optimized radiator configuration described in the detailed description, the blower fan operates at approximately 5200 RPM corresponding to the highest performance curve, enabling the system to overcome the pressure drop through the finned heat exchanger while delivering sufficient volumetric flow rate to achieve the target thermal resistance of 0.1001° C./W. The radiator assembly comprising fins with thickness of approximately 0.4 mm and fin pitch of approximately 1.5 mm creates a specific flow resistance that intersects with the fan performance curve at an airflow rate of approximately 20 to 22 CFM under the standardized test conditions of 100 W thermal load and 25° C. ambient temperature.

The fan performance data illustrated in FIG. 14 enables precise matching of the blower fan capabilities to the thermal dissipation requirements of the thermoelectric cold plate coolant system. The availability of multiple operating curves provides flexibility to adjust cooling capacity based on instantaneous thermal load, optimize power consumption during partial-load operation, maximize cooling performance during peak thermal load conditions, and balance acoustic noise considerations with thermal performance requirements. The systematic characterization of fan performance across the complete operating envelope facilitates computational fluid dynamics analysis and empirical validation of the radiator assembly thermal performance.

The pressure-flow characteristics shown in FIG. 14 demonstrate that the blower fan can deliver adequate airflow through the optimized fin geometry to dissipate 100 W of thermal power while maintaining the cold plate temperature within acceptable limits. The fan's ability to overcome static pressure up to 20.0 mm-H₂O ensures reliable operation even with dense fin arrays that maximize heat transfer surface area, and the maximum flow rate capability of approximately 118.0 CFM provides substantial margin for alternative radiator configurations or higher thermal load applications. This performance curve data is integral to the overall system design methodology and validates the achievability of the claimed thermal resistance values through proper integration of the thermoelectric cooling chips, liquid-cooled cold plate, and forced-air radiator assembly.

The following describes the integration of thermoelectric cold plate coolant system assembly 1200 into aluminum cooling chamber portable unit 200 to create a complete portable temperature-controlled enclosure system, according to some embodiments.

Thermoelectric cold plate coolant system assembly 1200 serves as the active cooling module that provides thermal management for aluminum cooling chamber portable unit 200. The four thermoelectric cooling chips 1206 mounted on cold plate 1204 are positioned to directly interface with the exterior surface of aluminum payload chamber 204 of the portable unit, creating a direct thermal conduction path for heat extraction from the payload chamber interior where temperature-sensitive materials are stored.

Thermoelectric chips 1206 are placed in direct thermal contact with the exterior surface of aluminum payload chamber 204 through soldering or thermally conductive bonding to eliminate thermal interface resistance between the cooling chips and the chamber wall. When electrical current is applied to thermoelectric chips 1206, the top surfaces of the chips actively extract heat from aluminum payload chamber 204 through the thermoelectric cooling effect created by electron mobility differentials at the semiconductor junctions. The extracted thermal energy is conducted through the chip structure to the bottom surfaces of thermoelectric chips 1206, where it transfers into cold plate 1204.

In one embodiment, thermoelectric chips 1206 can be mounted at a calculated angular orientation relative to the surface of aluminum payload chamber 204 rather than in a perpendicular configuration. The angular mounting orientation, preferably approximately 20 degrees relative to the chamber wall normal vector, creates radial heat distribution patterns that enhance cooling uniformity across the payload chamber surface area and accelerate temperature equalization throughout the chamber volume compared to conventional perpendicular mounting arrangements. The angular orientation increases the effective radius of cooling influence and improves the speed of thermal energy extraction from the payload chamber.

The thermal energy extracted from aluminum payload chamber 204 and conducted into cold plate 1204 is absorbed by liquid coolant circulating through the internal channels within the cold plate body. The heated coolant carrying the absorbed thermal energy flows through coolant outlet tube 1210 to radiator assembly 1202, where the thermal energy is dissipated to ambient air through forced convection provided by the integrated blower fan operating at approximately 5200 RPM. The cooled liquid returns through coolant inlet tube 1208 to cold plate 1204 to complete the closed-loop circulation, continuously removing heat from aluminum payload chamber 204 and maintaining the chamber interior at the target temperature range.

The closed-loop cooling system comprising thermoelectric cold plate coolant system assembly 1200 provides the liquid coolant circulation and heat dissipation capability for aluminum cooling chamber portable unit 200. The fluid-carrying pipes referenced in the portable unit description correspond to coolant outlet tube 1210 and coolant inlet tube 1208, which transport heated and cooled liquid coolant respectively between cold plate 1204 and radiator assembly 1202. A coolant circulation pump maintains continuous liquid flow through the closed-loop system at a flow rate sufficient to extract the thermal load from aluminum payload chamber 204 while avoiding pressure drops that would compromise system performance. The fan-assisted heat exchanger configuration comprises radiator assembly 1202 with its finned heat exchanger structure and integrated blower fan that dissipates thermal energy to the ambient environment.

The integrated system operates in a dual-power configuration to optimize energy efficiency and enable extended autonomous operation. During an initial cooldown phase, the system receives electrical power from an external AC power source through power cable 1212 to operate thermoelectric chips 1206, the coolant circulation pump, and the blower fan at full capacity. This high-power operation continues until aluminum payload chamber 204 reaches a target temperature of approximately 2° C., which typically requires approximately 2 hours from ambient starting conditions. Once the target temperature is achieved, the system can transition to battery-powered operation through a rechargeable lithium polymer battery assembly, enabling autonomous temperature control for approximately 72 hours without external power connection. During battery-powered operation, the system employs modulated cooling wherein thermoelectric chips 1206 activate in intermittent cooling bursts to compensate for temperature deviations from the target range, thereby extending battery life while maintaining temperature stability.

The portable unit can incorporate a thermal control material buffer system comprising phase-change materials or other thermal mass elements that absorb and release thermal energy to dampen temperature fluctuations within aluminum payload chamber 204. The thermal buffering reduces the duty cycle of active thermoelectric cooling during battery-powered operation, further extending autonomous operation duration while maintaining the payload chamber within the specified 2° C. to 8° C. temperature range.

The modular architecture of thermoelectric cold plate coolant system assembly 1200 enables flexible positioning of radiator assembly 1202 relative to cold plate 1204 and aluminum payload chamber 204 within the portable enclosure. In a top-loaded configuration, cold plate 1204 with affixed thermoelectric chips 1206 can be positioned at a midsection location along the wall of aluminum payload chamber 204, while radiator assembly 1202 is located externally or in a ventilated compartment where adequate airflow is available for heat dissipation. The portable enclosure incorporates ventilation openings, preferably with honeycomb or similar structured geometry, which provide air intake and exhaust paths enabling radiator assembly 1202 to draw ambient air, pass it through the finned heat exchanger structure, and exhaust the heated air to the environment. The ventilation design prevents ingress of contaminants while maximizing airflow to the radiator fins.

Thermoelectric cold plate coolant system assembly 1200 provides thermal load capacity of approximately 100 W, enabling the integrated system to achieve the performance specifications required for portable temperature-controlled storage applications. The system can cool aluminum payload chamber 204 from ambient temperature to approximately 2° C. within approximately 2 hours, and subsequently maintain the chamber within a 2° C. to 8° C. temperature range for approximately 72 hours on battery power. The optimized thermal resistance of approximately 0.1001° C./W achieved by assembly 1200 enables efficient heat extraction from a payload chamber volume of approximately 1 liter while maintaining compact overall enclosure dimensions of approximately 107.78 mm×119.92 mm×166.84 mm suitable for portable applications.

Temperature sensors positioned within or adjacent to aluminum payload chamber 204 provide real-time temperature measurements to a control system that regulates the electrical current applied to thermoelectric chips 1206. The control system implements closed-loop temperature regulation wherein the measured chamber temperature is compared to a target temperature or temperature range setpoint, and the thermoelectric chip current is modulated to maintain the measured temperature within acceptable limits. During active cooling, increased current to thermoelectric chips 1206 increases the cooling power and accelerates temperature reduction, while decreased current reduces cooling power and allows the chamber temperature to stabilize. The control system can employ proportional-integral-derivative control algorithms or other feedback control methodologies to minimize temperature overshoot, reduce settling time, and maintain stable temperature regulation with minimal power consumption.

The integration of thermoelectric cold plate coolant system assembly 1200 with aluminum cooling chamber portable unit 200 creates a complete portable temperature-controlled enclosure that combines the advantages of solid-state thermoelectric cooling with high-capacity liquid heat transport and forced-air heat dissipation. The integrated system provides silent operation due to the absence of compressor-based refrigeration components, precise temperature control through modulation of thermoelectric chip current, unlimited orientation capability enabled by single-phase liquid cooling without phase-change limitations, compact form factor through ultra-thin cold plate design and optimized component integration, extended battery-powered autonomous operation through efficient thermal management and optional thermal buffering, and reliable performance suitable for medical cold chain applications, pharmaceutical transport, biological sample storage, and other applications requiring portable temperature-controlled storage with high reliability and precise temperature maintenance.

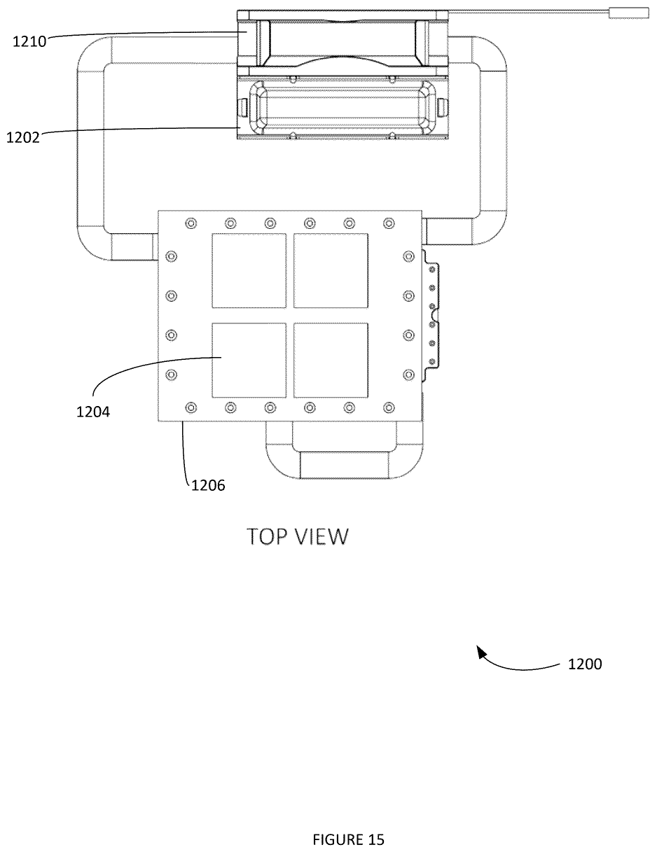

FIG. 15 illustrates a top view of thermoelectric cold plate coolant system 1200, according to some embodiments. The thermoelectric cold plate coolant system 1200 includes a heat exchanger 1202 coupled with a thermoelectric cooler array 1204 and a cold plate 1206, and further includes a coolant conduit 1210 routed around the assembly.

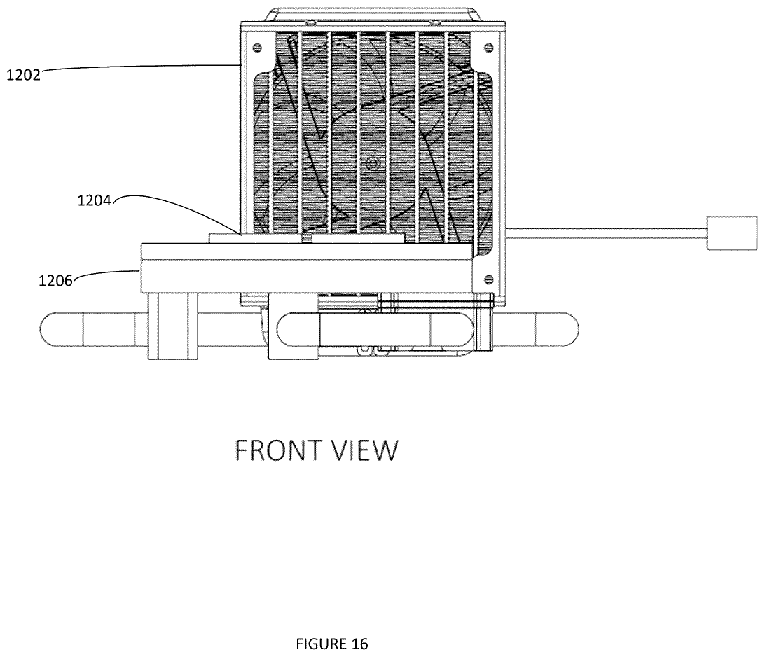

FIG. 16 illustrates a front view of thermoelectric cold plate coolant system 1200, according to some embodiments. The thermoelectric cold plate coolant system 1200 includes a heat exchanger 1202 coupled with a thermoelectric cooler array 1204 and a cold plate 1206.

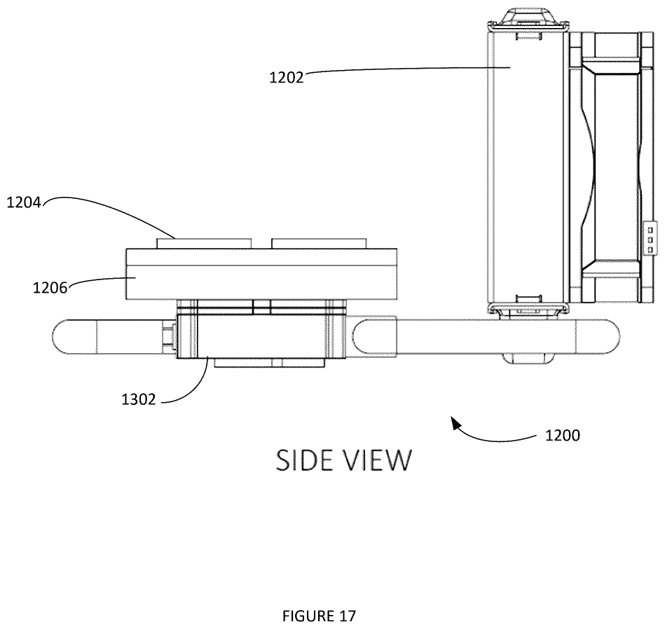

FIG. 17 illustrates a side view of thermoelectric cold plate coolant system 1200, according to some embodiments. The thermoelectric cold plate coolant system 1200 includes a heat exchanger 1202 coupled with a thermoelectric cooler array 1204 and a cold plate 1206, and further includes a pump block 1302 coupled with the thermoelectric cold plate coolant system 1200.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A thermoelectric cold plate coolant system comprising:
a cold plate body having a substantially planar top surface and a thickness of approximately 1 mm to 3 mm, said cold plate body constructed from a thermally conductive material and containing an internal network of coolant circulation channels;
a plurality of thermoelectric cooling chips affixed to said top surface of said cold plate body, each said thermoelectric cooling chip comprising a plurality of semiconductor pellet pairs arranged between electrically conductive traces, wherein electrical current applied to said conductive traces induces thermoelectric cooling at a top surface of each said chip and heat generation at a bottom surface of each said chip, wherein said thermoelectric cooling chips are permanently bonded to said cold plate body through soldering or thermally conductive adhesive bonding to eliminate thermal interface resistance;
a coolant inlet port and a coolant outlet port in fluid communication with said internal network of coolant circulation channels;
a radiator assembly in fluid communication with said coolant outlet port, said radiator assembly comprising a finned heat exchanger and a forced-air cooling device, wherein said radiator assembly is configured to dissipate thermal energy from heated liquid coolant to ambient air through forced convection;
a coolant circulation pump configured to maintain continuous single-phase liquid circulation through a closed loop comprising said cold plate body and said radiator assembly, wherein said liquid coolant remains in liquid phase throughout said closed loop during normal operation; and
an electrical power supply configured to provide electrical power to said thermoelectric cooling chips, said coolant circulation pump, and said forced-air cooling device.

2. The thermoelectric cold plate coolant system of claim 1, wherein said cold plate body has dimensions of approximately 80 mm by 80 mm and a thickness of approximately 1 mm, and wherein said internal network of coolant circulation channels is formed within said cold plate body to provide thermal coupling with said bottom surfaces of said thermoelectric cooling chips while maintaining structural integrity of said cold plate body.

3. The thermoelectric cold plate coolant system of claim 1, wherein said plurality of thermoelectric cooling chips comprises four thermoelectric cooling chips arranged on said top surface of said cold plate body, and wherein each said thermoelectric cooling chip has dimensions of approximately 20 mm by 20 mm.

4. The thermoelectric cold plate coolant system of claim 1, wherein each said thermoelectric cooling chip comprises either a first configuration containing approximately 128 pairs of semiconductor pellets with each pellet measuring approximately 0.5 mm by 0.5 mm by 0.5 mm, or a second configuration containing approximately 50 pairs of semiconductor pellets with each pellet measuring approximately 1 mm by 1 mm by 1 mm, wherein both said first configuration and said second configuration occupy substantially identical chip footprints enabling direct substitution without modification to said cold plate body.

5. The thermoelectric cold plate coolant system of claim 4, wherein said first configuration provides finer temperature control granularity and improved coefficient of performance under partial-load conditions, and wherein said second configuration provides higher current handling capacity and improved efficiency under high-flux conditions.

6. The thermoelectric cold plate coolant system of claim 1, wherein said semiconductor pellets are composed of bismuth telluride, and wherein said electrically conductive traces are composed of copper with a thickness of approximately 0.05 mm.

7. The thermoelectric cold plate coolant system of claim 1, wherein said radiator assembly comprises fins having a thickness of approximately 0.4 mm and a fin pitch of approximately 1.5 mm, and wherein said radiator assembly includes approximately six heat pipes penetrating through said fins, each said heat pipe capable of transferring approximately 25 W of thermal power.

8. The thermoelectric cold plate coolant system of claim 7, wherein said forced-air cooling device operates at approximately 5200 RPM to provide sufficient airflow to dissipate a total thermal load of approximately 100 W when operating at an ambient air temperature of approximately 25° C.

9. The thermoelectric cold plate coolant system of claim 7, wherein said radiator assembly achieves a thermal resistance of approximately 0.1001° C./W when dissipating a 100 W thermal load, said thermal resistance representing approximately a 45% improvement over a baseline radiator configuration through synergistic optimization of fin thickness, fin pitch, forced-air cooling device speed, and heat pipe configuration.

10. The thermoelectric cold plate coolant system of claim 1, wherein said system achieves volumetric power density exceeding 0.8 W/cm³ while operating exclusively with solid-state thermoelectric devices without compressor-based refrigeration components, rotary refrigerant compressors, or vapor-compression cycles.

11. The thermoelectric cold plate coolant system of claim 1, wherein said single-phase liquid circulation architecture eliminates wick structures and associated capillary limitations to enable orientation-independent operation, and wherein maximum thermal load capacity can be increased by raising coolant flow rate without being fundamentally limited by vapor transport physics.

12. The thermoelectric cold plate coolant system of claim 1, further comprising a payload chamber having an exterior surface in thermal contact with said top surfaces of said thermoelectric cooling chips, wherein heat-generating components or temperature-sensitive materials placed within said payload chamber are actively cooled through thermal energy extraction by said thermoelectric cooling chips.

13. The thermoelectric cold plate coolant system of claim 12, wherein said thermoelectric cooling chips are mounted at an angular orientation of approximately 20 degrees relative to a normal vector of said exterior surface of said payload chamber, wherein said angular orientation creates radial heat distribution patterns that enhance cooling uniformity across said payload chamber surface area and accelerate temperature equalization throughout said payload chamber volume compared to perpendicular mounting configurations.

14. The thermoelectric cold plate coolant system of claim 12, further comprising a temperature sensor positioned to measure temperature within said payload chamber, and a control system configured to regulate electrical current applied to said thermoelectric cooling chips based on said measured temperature to maintain said payload chamber within a target temperature range.

15. The thermoelectric cold plate coolant system of claim 14, wherein said control system implements dual-power operation comprising an initial cooldown phase utilizing external AC power to operate said thermoelectric cooling chips at full capacity until said payload chamber reaches a target temperature, followed by battery-powered operation enabling autonomous temperature control for approximately 72 hours through modulated cooling wherein said thermoelectric cooling chips activate in intermittent cooling bursts to compensate for temperature deviations from said target temperature range.
